(19) United States
(12) Patent Application Publication
(10) Pub. No.: US 2026/0340438 A1
(43) Pub. Date: Oct. 29, 2026

(54) ELECTRONIC DEVICES AND METHODS FOR PERSONALIZATION OF ARTIFICIAL INTELLIGENCE MODEL

(71) Applicant: POSTECH RESEARCH AND BUSINESS DEVELOPMENT FOUNDATION, Pohang-si (KR)

(72) Inventors: Jungseul Ok, Pohang-si (KR); Dongwoo KIM, Pohang-si (KR); Youngbin CHOI, Pohang-si (KR); Seunghyuk CHO, Pohang-si (KR); Minjong LEE, Pohang-si (KR); MoonJeong PARK, Pohang-si (KR); Yesong KO, Pohang-si (KR)

(73) Assignee: POSTECH RESEARCH AND BUSINESS DEVELOPMENT FOUNDATION, Pohang-si (KR)

(21) Appl. No.: 19/441,713

(22) Filed: Jan. 6, 2026

(30) Foreign Application Priority Data
Apr. 29, 2025 (KR) 10-2025-0056325

(51) Int. Cl. G06N 5/022

(52) U.S. Cl. CPC G06N 5/022

(57) ABSTRACT

Electronic devices and methods for personalization of artificial intelligence model are provided. The electronic device for personalizing an artificial intelligence model, comprising: a processor; and a memory operatively coupled to the processor, wherein the memory stores instructions that, when executed, cause the processor to: identify a bipartite graph based on a first user and a first response of the first user, identify a first latent variable reflecting a preference of the first user based on the bipartite graph, and connect the first user to one of at least one sub-module included in a first artificial intelligence model based on the first latent variable, and wherein the first response comprises at least one output generated by the first artificial intelligence model and a preference of the first user for the at least one output.

### CROSS-REFERENCE TO RELATED APPLICATION

This application claims priority under 35 U.S.C §119 to Korean Patent Application No. 10-2025-0056325 filed on Apr. 29, 2025, in the Korean Intellectual Property Office, the entire contents of which are hereby incorporated by reference.

### TECHNICAL FIELD

The disclosure relates to electronic devices and methods for personalization of an artificial intelligence model, and to collaborative preference learning (CoPL).

### BACKGROUND

The content set forth in this section merely provides background information on the present embodiments and does not constitute prior art.

Artificial intelligence models, such as large-scale language models, are utilized in various natural language processing applications and can generate outputs tailored to user preferences. Recently, methods in which artificial intelligence models generate outputs tailored to user preferences via reinforcement learning from human feedback (RLHF) have been used.

In order for artificial intelligence models to generate outputs tailored to user preferences, a method in which multiple users label their preferred outputs out of output pairs generated for the same question, and a common reward function is used for training without considering user information, is primarily utilized. This method has a problem in that all users are treated as a single group without reflecting the individual preferences of each of the plurality of users, and thereby only the average preferences may be reflected.

Furthermore, a method of training an artificial intelligence model using latent variables that reflect the preferences of each of the plurality of users has been proposed; however, generating a reward function for each of the plurality of users may lead to data load and cost issues, and furthermore, there may be a problem arising from the failure to train with the preferences of users not included in the plurality of users.

Therefore, there has been a need for a technology that can estimate the preferences of unseen users while reflecting the preferences of each of the plurality of users in order to solve the problems of existing methods.

### PRIOR ART LITERATURE

### Patent Documents

Korean Patent No. 10-2770565 (Feb. 17, 2025)

### SUMMARY

It is an object of the present disclosure to provide an electronic device and method for personalization of an artificial intelligence model, which can efficiently train the artificial intelligence model by reflecting the preferences of each of a plurality of users.

Furthermore, it is an object of the present disclosure to provide an electronic device and method for personalization of an artificial intelligence model, which can estimate the preferences of unseen users.

The objects of the present disclosure are not limited to the objects mentioned above, and other objects and advantages of the present disclosure that have not been mentioned can be understood by the following description and will be understood more clearly by the embodiments of the present disclosure. Further, it will be readily appreciated that the objects and advantages of the present disclosure can be realized by the means set forth in the claims and combinations thereof.

According to some embodiments of the present disclosure, an electronic device for personalizing an artificial intelligence model, comprising: a processor; and a memory operatively coupled to the processor, wherein the memory stores instructions that, when executed, cause the processor to: identify a bipartite graph based on a first user and a first response of the first user, identify a first latent variable reflecting a preference of the first user based on the bipartite graph, and connect the first user to one of at least one sub-module included in a first artificial intelligence model based on the first latent variable, and wherein the first response comprises at least one output generated by the first artificial intelligence model and a preference of the first user for the at least one output.

According to some embodiments of the present disclosure, wherein the bipartite graph: comprises, as nodes, each of the first user and the at least one output for which the first user has indicated a preference, and comprises an edge connecting the node of the first user and the node of the at least one output.

According to some embodiments of the present disclosure, wherein, based on the first user having provided feedback on a first output of the at least one output as a preferred output, the bipartite graph comprises the node of the first user and the node of the first output being connected by a first edge.

According to some embodiments of the present disclosure, wherein, based on the first user having provided feedback on a second output of the at least one output as a non-preferred output, the bipartite graph comprises the node of the first user and the node of the second output being connected by a first negative edge.

According to some embodiments of the present disclosure, wherein the instructions cause the processor to: input the first response into a second artificial intelligence model, and receive the bipartite graph from the second artificial intelligence model.

According to some embodiments of the present disclosure, herein the instructions cause the processor to: input the bipartite graph into a third artificial intelligence model, and receive the first latent variable for the first user from the third artificial intelligence model.

According to some embodiments of the present disclosure, wherein the first latent variable reflects preferences of the first user for each of the at least one output.

According to some embodiments of the present disclosure, wherein, based on the first user having provided feedback on a first output of the at least one output as a preferred output, and a second user having provided feedback on the first output of the at least one output as a preferred output, the bipartite graph comprises: a node of the first user and a node of the first output being connected by a first edge, and a node of the second user and the node of the first output being connected by a second edge, and wherein the first latent variable for the first user and a second latent variable for the second user, which are connected to each other via the node of the first output, have similar values within a predetermined error range.

According to some embodiments of the present disclosure, wherein the second latent variable reflects a preference of the second user based on the bipartite graph, and wherein the instructions cause the processor to: input the bipartite graph into a third artificial intelligence model, and receive the first latent variable and the second latent variable from the third artificial intelligence model.

According to some embodiments of the present disclosure, herein the instructions cause the processor to: input the first latent variable into a fourth artificial intelligence model, and receive information on a probability that the first user and each of the at least one sub-module will be connected, from the fourth artificial intelligence model.

According to some embodiments of the present disclosure, wherein the instructions cause the processor to: connect the first user to a sub-module having the highest probability out of the at least one sub-module, based on the information.

According to some embodiments of the present disclosure, wherein the instructions cause the processor to: identify an unseen user not included in the bipartite graph and a second response comprising a preference of the unseen user for the at least one output, and based on the second response including having fed back preferences for a first output and a second output of the at least one output, identify the first user connected via the first output, identify a probability that the first user prefers both the first output and the second output, and identify a second latent variable for the unseen user based on the probability and the first latent variable for the first user.

According to some embodiments of the present disclosure, wherein the instructions cause the processor to: input the first latent variable for the first user into a fifth artificial intelligence model, and receive and identify the probability from the fifth artificial intelligence model.

According to some embodiments of the present disclosure, a method for personalizing an artificial intelligence model, comprising the steps of: identifying a bipartite graph based on a first user and a first response of the first user; identifying a first latent variable reflecting a preference of the first user based on the bipartite graph; and connecting the first user to one of at least one sub-module included in a first artificial intelligence model based on the first latent variable, wherein the first response comprises at least one output generated by the first artificial intelligence model and a preference of the first user for the at least one output.

According to some embodiments of the present disclosure, wherein the bipartite graph: comprises, as nodes, each of the first user and the at least one output for which the first user has indicated a preference, and comprises an edge connecting the node of the first user and the node of the at least one output.

According to some embodiments of the present disclosure, wherein the step of identifying the bipartite graph comprises the steps of: inputting the first response into a second artificial intelligence model; and receiving the bipartite graph from the second artificial intelligence model.

According to some embodiments of the present disclosure, wherein the step of identifying the first latent variable comprises the steps of: inputting the bipartite graph into a third artificial intelligence model; and receiving the first latent variable for the first user from the third artificial intelligence model.

According to some embodiments of the present disclosure, an electronic device for personalizing an artificial intelligence model, comprising: a processor; and a memory operatively coupled to the processor, wherein the memory stores instructions that, when executed, cause the processor to: identify a bipartite graph based on a first user and a first response of the first user, identify, by using a first artificial intelligence model, a first latent variable reflecting a preference of the first user from the bipartite graph, and identify, by using a second artificial intelligence model, the first user being connected to one of at least one sub-module included in the first artificial intelligence model based on the first latent variable, and wherein the first response comprises at least one output generated by a third artificial intelligence model and a preference of the first user for the at least one output.

According to some embodiments of the present disclosure, wherein the instructions cause the processor to: input the first response to a fourth artificial intelligence model, and receive the bipartite graph from the fourth artificial intelligence model.

According to some embodiments of the present disclosure, wherein the first latent variable reflects preferences of the first user for each of the at least one output.

The electronic device and method for personalization of an artificial intelligence model of the present disclosure can efficiently train artificial intelligence models by reflecting the preferences of each of a plurality of users through latent variables.

Furthermore, the electronic device and method for personalization of an artificial intelligence model of the present disclosure eliminate the need for additional optimization steps by estimating the preferences of unseen users using latent variables.

In addition to the foregoing description, specific effects of the present disclosure will be stated together while describing specific details for implementing the present disclosure below.

### BRIEF DESCRIPTION OF THE DRAWINGS

FIG. 1 is a diagram for describing an electronic device for personalization of an artificial intelligence model in accordance with an embodiment of the present disclosure.

FIG. 2 is a flowchart for describing the operation of the processor of FIG. 1.

FIGS. 3, 4, and 5 are diagrams for describing step S100 of FIG. 2.

FIG. 6 is a diagram for describing step S300 of FIG. 2.

FIG. 7 is a diagram for describing the operation of a processor of an electronic device for personalization of an artificial intelligence model in accordance with an embodiment of the present disclosure.

FIG. 8 is a flowchart for describing a method for personalizing an artificial intelligence model in accordance with an embodiment of the present disclosure.

### DETAILED DESCRIPTION OF THE PREFERRED EMBODIMENTS

The terms or words used in the present specification and the claims should not be interpreted as being limited to their general or dictionary meanings. In accordance with the principle that the inventor may define the concepts of terms or words to best describe his or her invention, they should be interpreted based on the meanings and concepts consistent with the technical idea of the present invention. Furthermore, the embodiments described in the present specification and the configurations illustrated in the drawings are merely examples for realizing the invention and do not represent the entirety of the technical idea of the present invention. It should be understood that, at the time of filing, there may be various equivalents, modifications, and applicable examples that can replace these embodiments.

The terms such as “first,” “second,” “A,” “B,” and the like, used in the present specification and the claims, may be used to describe various components, but such components should not be limited by these terms. These terms are merely used to distinguish one component from another. For example, without departing from the scope of the present invention, a first component may be referred to as a second component, and similarly, the second component may be referred to as the first component. The term “and/or” includes any combination of the related listed items or any one of the related listed items.

The terms used in the present specification and the claims are used merely to describe particular embodiments and are not intended to limit the invention. Unless clearly indicated otherwise by the context, singular expressions include plural expressions. In this application, the terms such as “include” or “have” should be understood as indicating the presence or possibility of addition of features, numbers, steps, operations, elements, parts, or combinations thereof described in the specification, without precluding the existence or addition of one or more other features, numbers, steps, operations, elements, parts, or combinations thereof.

Unless otherwise defined, all terms used herein, including technical or scientific terms, have the same meanings as those generally understood by a person of ordinary skill in the technical field to which the present invention pertains.

Terms defined in commonly used dictionaries should be interpreted as having meanings consistent with their meanings in the relevant technical context, and unless explicitly defined in this application, should not be interpreted in an idealized or excessively formal sense. Furthermore, each structure, process, procedure, or method included in the embodiments of the present invention may be shared to the extent that they do not technically contradict each other.

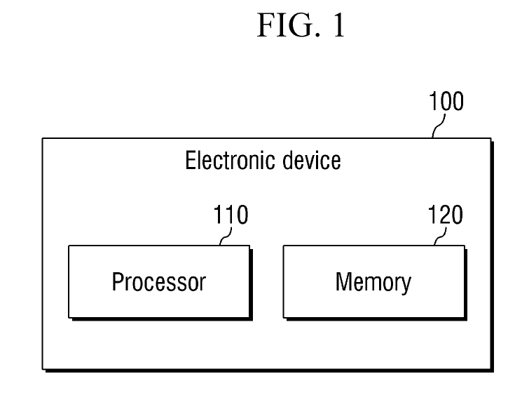

Hereinafter, an electronic device for personalization of an artificial intelligence model according to an embodiment of the present disclosure will be described with reference to FIGS. 1 to 7.

FIG. 1 is a diagram for describing an electronic device for personalization of an artificial intelligence model in accordance with an embodiment of the present disclosure.

Referring to FIG. 1, an electronic device (hereinafter, “electronic device”) 100 for personalization of an artificial intelligence model may include a processor 110 and a memory 120.

One or more other components (e.g., a communication module) may be added to the electronic device 100. In some embodiments, some of these components may be implemented in a single integrated circuit.

The memory 120 may store various data used by at least one component (e.g., the processor 110) of the electronic device 100. The data may include, for example, software (e.g., programs) and input or output data for commands associated therewith. The memory 120 may include volatile memory or non-volatile memory.

The memory 120 may store commands, information, or data associated with the operation of the components included in the electronic device 100. For example, the memory 120 may store instructions that, when executed, enable the processor 110 to perform the various operations described herein.

The processor 110 may be operatively coupled to the memory 120 in order to perform the overall functions of the electronic device 100. The processor 110 may include, for example, one or more processors. The one or more processors may include, for example, an image signal processor (ISP), an application processor (AP), or a communication processor (CP).

The processor 110 may control at least one other component (e.g., a hardware or software component) of the electronic device 100 coupled to the processor 110 by executing, for example, software (e.g., a program), and perform various data processing or calculations. According to one embodiment, as at least part of the data processing or calculations, the processor 110 may load commands or data received from other components (e.g., a communication module) into the memory 120, process the commands or data stored in the memory 120, and store the resulting data in the memory 120. According to one embodiment, the processor 110 may include a main processor (e.g., a central processing unit or application processor) and an auxiliary processor (e.g., a graphics processing unit, image signal processor, sensor hub processor, or communication processor) that can operate independently or together with the main processor. Additionally or alternatively, the auxiliary processor may be set to use less power than the main processor or to be specialized for specified functions. The auxiliary processor may be implemented separately from or as part of the main processor. The program may be stored as software in the memory 120 and may include, for example, an operating system, middleware, or an application.

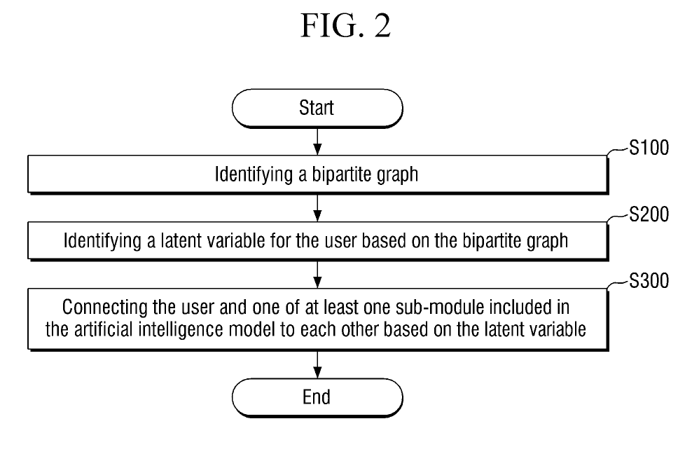

FIG. 2 is a flowchart for describing the operation of the processor of FIG. 1.

Referring to FIGS. 1 and 2, the processor 110 may first identify a bipartite graph (S100) for personalizing an artificial intelligence model. The processor 110 may identify the bipartite graph based on a first user and a first response.

The first user may be a user terminal of a first artificial intelligence model. The first user may be a user terminal who entered a question into the first artificial intelligence model. The first user may be a user terminal who entered a question into the first artificial intelligence model, and fed back a preference for at least one output when the first artificial intelligence model provided the at least one output. The at least one output may be, for example, an answer to the question of the first user.

The first response may include the at least one output generated by the first artificial intelligence model and preferences of the first user for the at least one output. For example, if the first user enters a question into the first artificial intelligence model and a first output and a second output are outputted from the first artificial intelligence model, and then if the first user feeds back a positive preference (positive feedback) for the first output and a negative preference (negative feedback) for the second output, the first response may include the first output, the second output, the feedback by the first user on the first output (e.g., a positive preference), and the feedback by the first user on the second output (e.g., a negative preference).

The first artificial intelligence model may be a model that provides an output in accordance with an input (e.g., an answer to a question) based on the input of the user (e.g., a question). The first artificial intelligence model may be, for example, a large language model (LLM).

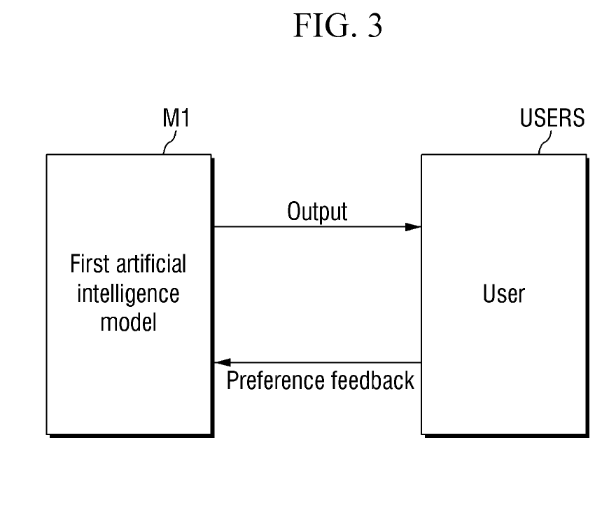

FIGS. 3, 4, and 5 are diagrams for describing step S100 of FIG. 2.

Referring to FIG. 3, the bipartite graph may include users and responses. The response may include an output and preference feedback. The output may be an answer to an input (e.g., an answer to a question) provided by the first artificial intelligence model M1 for the input (e.g., question) from the user USERS. The preference feedback may be an indication of preferences by the user USERS for the at least one output of the first artificial intelligence model M1.

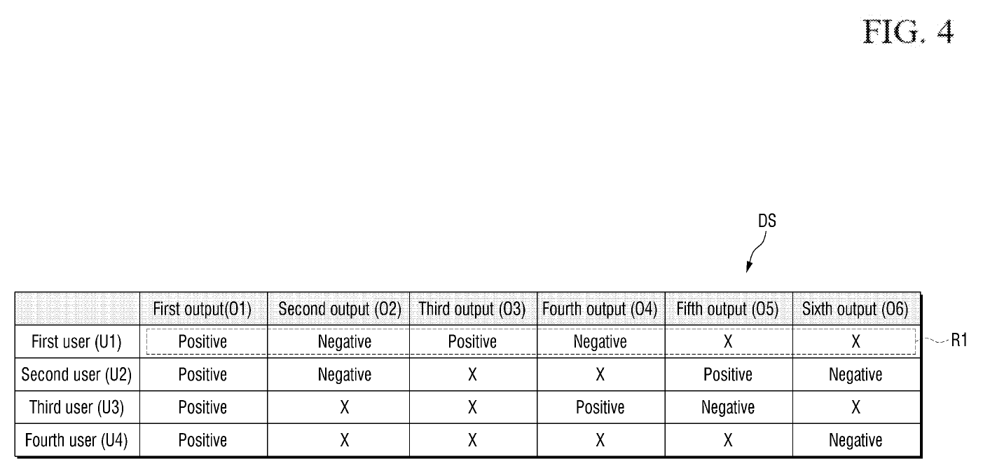

Referring to FIG. 4, preference feedback results for each of the at least one output O1, O2, O3, O4, O5, and O6 of the first artificial intelligence model M1 for each of the plurality of users USERS and a data set DS containing information about each of the plurality of users USERS may be identified by the processor 110. The processor 110 may identify, for each user, the preference feedback results for each of the at least one output O1, O2, O3, O4, O5, and O6 of the first artificial intelligence model M1 as the data set DS.

The plurality of users USERS (e.g., a first user U1, a second user U2, a third user U3, and a fourth user U4) may feed back preferences for some or all of the at least one output O1, O2, O3, O4, O5, and O6 of the first artificial intelligence model M1.

For example, the first user USERS may feed back positive preferences (Positive) for the first output O1 and the third output O3, and negative preferences (Negative) for the second output O2 and the fourth output O4. The first user USERS may not have been provided with the fifth output O5 and the sixth output O6, or the first user USERS may not have fed back preferences for the fifth output O5 and the sixth output O6. The first response R1 of the first user USERS may include preference feedback results of the first user USERS for each of the at least one output (e.g., O1, O2, O3, O4) of the first artificial intelligence model M1.

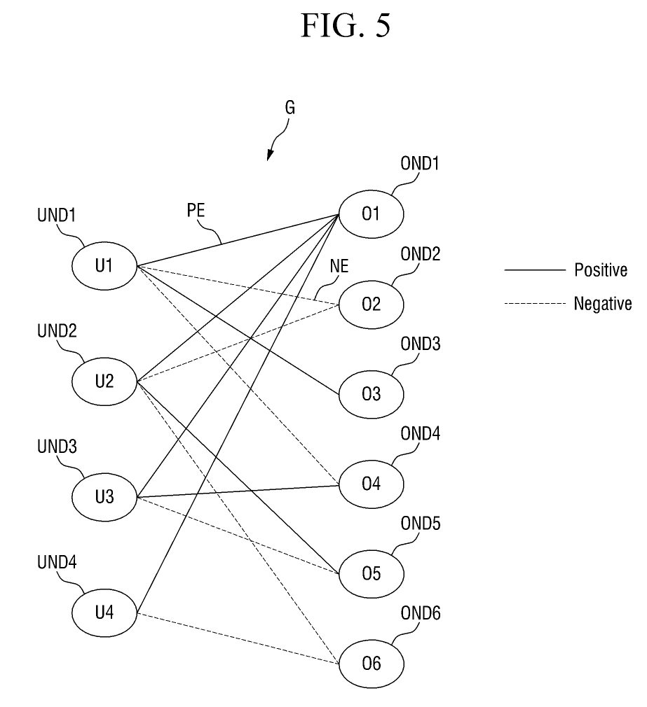

Referring to FIG. 5, the processor 110 may identify a bipartite graph G based on the data set DS. The bipartite graph G may include a plurality of nodes and a plurality of edges. The bipartite graph G of FIG. 5 is a graph generated based on the data set DS of FIG. 4 and serves as one example.

The bipartite graph G may include a plurality of user nodes UND1, UND2, UND3, and UND4 associated with users. The plurality of user nodes UND1, UND2, UND3, and UND4 may be created as many as the number of users included in the data set DS.

The bipartite graph G may include a plurality of output nodes OND1, OND2, OND3, OND4, OND5, and OND6 associated with at least one output for which the user has indicated preferences. The plurality of output nodes OND1, OND2, OND3, OND4, OND5, and OND6 may be created as many as the number of outputs generated by the artificial intelligence model (e.g., the first artificial intelligence model M1) based on the data set DS.

The bipartite graph G may include a plurality of edges connecting the plurality of user nodes UND1, UND2, UND3, and UND4 and the plurality of output nodes OND1, OND2, OND3, OND4, OND5, and OND6. The plurality of edges may include positive edges PE and negative edges NE.

Depending on the preference feedback, the user nodes and the output nodes may be connected by either positive edges PE or negative edges NE. If one of the plurality of users has fed back a positive preference (Positive) for an output, the user node of the user and the output node of the output may be connected to each other by a positive edge PE. If one of the plurality of users has fed back a negative preference (Negative) for an output, the user node of the user and the output node of the output may be connected to each other by a negative edge NE.

For example, referring to the data set DS, since the first user USERS has fed back positive preferences for the first output O1 and the third output O3 of the at least one output of the first artificial intelligence model M1, the first user node UND1 of the first user USERS and the first output node OND1 of the first output O1 may be connected by a positive edge PE, and the first user node UND1 and the third output node OND3 of the third output O3 may be connected by a positive edge PE. Referring to the data set DS, since the first user USERS has fed back negative preferences for the second output O2 and the fourth output O4 of the at least one output of the first artificial intelligence model M1, the first user node UND1 of the first user USERS and the second output node OND2 of the second output O2 may be connected by a negative edge NE, and the first user node UND1 and the fourth output node OND4 of the fourth output O4 may be connected by a negative edge NE. Since there is no preference feedback of the first user USERS for the fifth output O5 and the sixth output O6, the first user node UND1 and the fifth output node OND5 and the sixth output node OND6 may not be connected to each other.

In some embodiments, the processor 110 may input the first response R1 into a second artificial intelligence model and receive the bipartite graph G from the second artificial intelligence model. The processor 110 may input the data set DS containing the first response R1 into the second artificial intelligence model. The processor 110 may identify the bipartite graph G generated based on the data set DS containing the first response R1 from the second artificial intelligence model. The second artificial intelligence model may be, for example, an artificial intelligence model capable of generating graphs based on data.

Referring again to FIGS. 1 and 2, the processor 110 may identify latent variables for the users based on the bipartite graph (S200). The processor 110 may identify a latent variable for each of the plurality of users included in the bipartite graph based on the bipartite graph.

The latent variable may reflect the preference of each of the plurality of users for the at least one output of the artificial intelligence model. The latent variable may be a numerical value representing the result of each of the plurality of users feeding back their preferences for each of the at least one output of the first artificial intelligence model.

For example, the processor 110 may identify a first latent variable for the first user based on the bipartite graph. For example, the first latent variable may reflect the preference of the first user. For example, the first latent variable may reflect the preference feedback results of the first user for each of the at least one output of the first artificial intelligence model. The first latent variable may be the result of representing, in a numerical value, the preference feedback of the first user for each of the at least one output of the first artificial intelligence model.

Referring to FIGS. 1, 2, and 5, the first user node UND1 and the second user node UND2 are connected via a single output node, the first output node OND1. That is, the first user node UND1 and the second user node UND2 may be in a two-hop relationship. In this case, the first latent variable for the first user USERS and the second latent variable for the second user USERS may have similar values within a certain error range. For example, the latent variables for the users in a two-hop relationship may have similar values by training.

In some embodiments, the processor 110 may input the bipartite graph into a third artificial intelligence model and receive latent variables for each of the plurality of users from the third artificial intelligence model. The third artificial intelligence model may be, for example, a model capable of explicitly modeling multi-hop relationships. The third artificial intelligence model may be, for example, a graph neural network (GNN).

Referring again to FIGS. 1 and 2, the processor 110 may connect the user and one of at least one sub-module included in the artificial intelligence model to each other based on the latent variable (S300).

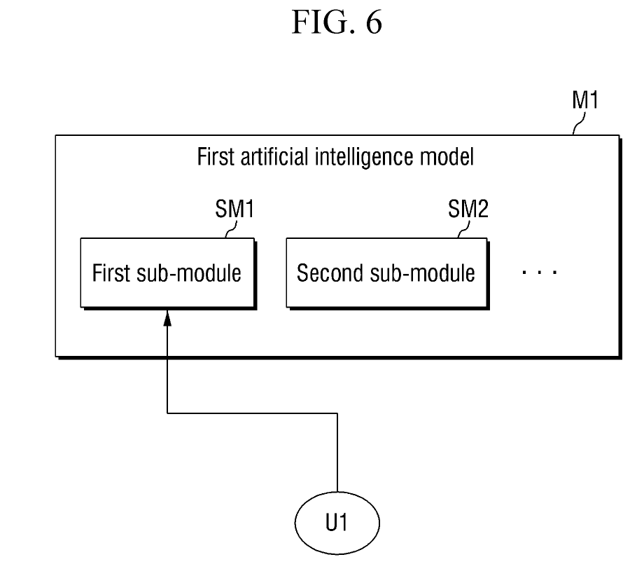

FIG. 6 is a diagram for describing step S300 of FIG. 2.

Referring to FIGS. 1, 2, and 6, the first artificial intelligence model M1 may include at least one sub-module SM1, SM2, …. The processor 110 may connect the first user and one of the at least one sub-module included in the first artificial intelligence model M1 to each other, for example, based on the first latent variable for the first user.

For example, when the first user enters a question into the first artificial intelligence model M1, the processor 110 may assign a first sub-module SM1 of the at least one sub-module based on the first latent variable. By utilizing the first sub-module SM1, an output (an answer to the question) with a high preference by the first user may be provided to the first user.

In some embodiments, the processor 110 may input the latent variable into a fourth artificial intelligence model and receive, from the fourth artificial intelligence model, information on the probability that the user will be connected to each of the at least one sub-module. Based on the information, the processor 110 may cause the sub-module with the highest probability to be connected (or matched) to the user. The fourth artificial intelligence model may be a model that predicts which of the sub-modules a user will select. The fourth artificial intelligence model may be, for example, a gating model.

The electronic device for personalization of an artificial intelligence model in accordance with an embodiment of the present disclosure can satisfy the preferences of various users with a single artificial intelligence model by identifying a bipartite graph and latent variables based on user preferences of the artificial intelligence model and connecting sub-models included in the large artificial intelligence model to the user based on the latent variables. Thereby, because a single large artificial intelligence model can be personalized for users and outputs tailored to the preferences of each user can be provided from the artificial intelligence model even if the same single artificial intelligence model is used together with other users, user satisfaction and utility can be enhanced.

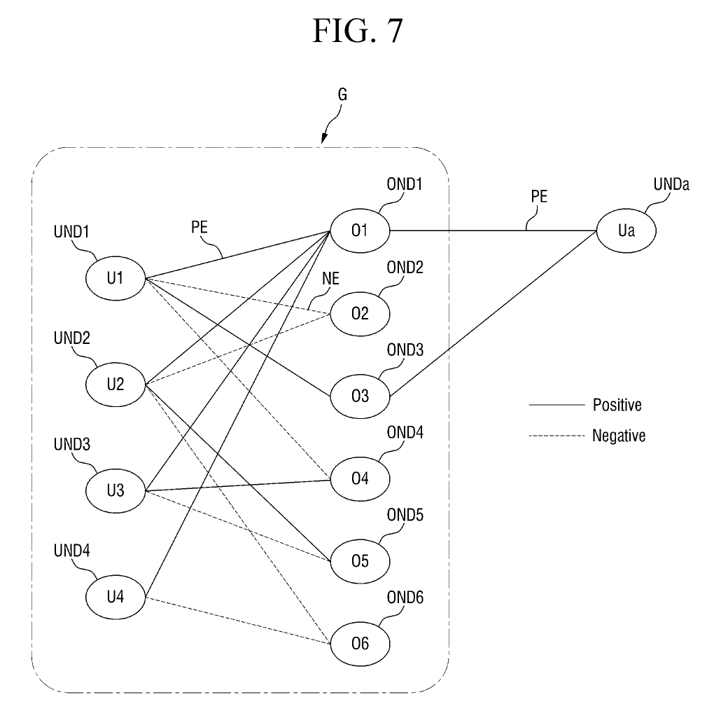

FIG. 7 is a diagram for describing the operation of a processor of an electronic device for personalization of an artificial intelligence model in accordance with an embodiment of the present disclosure.

Referring to FIG. 7, when a second response of an unseen user Ua not included in the bipartite graph G is identified in relation to the first artificial intelligence model (M1 in FIG. 3), the processor 110 may identify a latent variable for the unseen user Ua without modifying the bipartite graph G or further training the first artificial intelligence model.

The processor 110 may identify the second response that includes the preference of the unseen user Ua for the at least one output of the first artificial intelligence model M1. Based on the second response, the processor 110 may identify at least one user (i.e., user node) connected to the output (i.e., output node) for which the unseen user Ua has fed back a positive preference. The processor 110 may identify the probability that each of at least one user will feed back positive preferences for all outputs for which the unseen user Ua has fed back positive preferences, and identify the latent variable for the unseen user Ua based on the probability.

For example, the second response of the unseen user Ua may include the result of feeding back positive preferences (Positive) for the first output O1 and the third output O3 of the at least one output. The processor 110 may identify first to fourth users U1, U2, U3, and U4 that are connected via the first output node OND1 of the first output O1 and are in a two-hop relationship with the unseen user Ua, and may identify the first user U1 that is connected via the third output node OND3 of the third output O3 and is in a two-hop relationship with the unseen user Ua. The processor 110 may identify the probability that each of the first to fourth users U1, U2, U3, and U4 will prefer both the first output O1 and the third output O3 for which the unseen user Ua has fed back positive preferences. In other words, the processor 110 may identify the probability that each of the first to fourth users U1, U2, U3, and U4 will feed back positive preferences for both the first output O1 and the third output O3.

The processor 110 may identify the latent variable for the unseen user Ua based on the probability for each of the first to fourth users U1, U2, U3, and U4 and the latent variable for each of the first to fourth users U1, U2, U3, and U4. For example, the processor 110 may normalize the probability for each of the first to fourth users U1, U2, U3, and U4, and multiply each normalized probability by the latent variable for each of the first to fourth users U1, U2, U3, and U4, thereby identifying the latent variable for the unseen user Ua.

The processor 110 may perform personalization for the unseen user Ua by connecting the unseen user Ua to one of the at least one sub-module of the first artificial intelligence model M1 based on the latent variable for the unseen user Ua, and provide an output (i.e., an answer to the input of the unseen user) for which the unseen user Ua is highly likely to feed back a positive preference.

In some embodiments, the processor 110 may input the latent variable for each of the at least one user into a fifth artificial intelligence model and receive probabilities from the fifth artificial intelligence model. The fifth artificial intelligence model may be, for example, a graph neural network (GNN).

The electronic device for personalization of an artificial intelligence model in accordance with an embodiment of the present disclosure can perform personalization of an artificial intelligence model even for an unseen user by estimating the latent variable for the unseen user using the previously identified bipartite graph and latent variables without modifying the bipartite graph or further training the artificial intelligence model even when the unseen user, who is not a target for training, uses the artificial intelligence model.

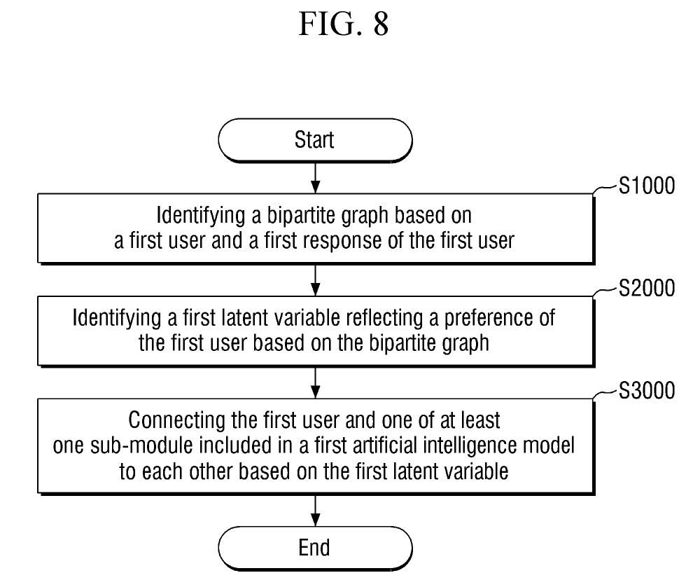

In the following, a method for personalizing an artificial intelligence model in accordance with an embodiment of the present disclosure will be described with reference to FIG. 8. For clarity of description, any parts that overlap with those described above will be omitted.

FIG. 8 is a flowchart for describing a method for personalizing an artificial intelligence model in accordance with an embodiment of the present disclosure.

Referring to FIG. 8, the method for personalizing an artificial intelligence model in accordance with an embodiment of the present disclosure may include a step (S1000) of identifying a bipartite graph based on a first user and a first response of the first user.

The method for personalizing an artificial intelligence model in accordance with an embodiment of the present disclosure may include a step (S2000) of identifying a first latent variable reflecting a preference of the first user based on the bipartite graph.

The method for personalizing an artificial intelligence model in accordance with an embodiment of the present disclosure may include a step (S3000) of connecting the first user and one of at least one sub-module included in a first artificial intelligence model based on the first latent variable.

The method for personalizing an artificial intelligence model in accordance with an embodiment of the present disclosure may include a step of identifying an unseen user not included in the bipartite graph and a second response including a preference of the unseen user for at least one output.

The method for personalizing an artificial intelligence model in accordance with an embodiment of the present disclosure may include a step of identifying the first user connected via a first output, based on the second response including feedback of preferences for the first output and a second output of the at least one output.

The method for personalizing an artificial intelligence model in accordance with an embodiment of the present disclosure may include a step of identifying a probability that the first user will prefer both the first output and the second output.

The method for personalizing an artificial intelligence model in accordance with an embodiment of the present disclosure may include a step of identifying a second latent variable for the unseen user based on the probability and the first latent variable for the first user.

The above description is merely illustrative of the technical ideas of the present embodiment, and it will be apparent to those of ordinary skill in the art to which the present embodiment pertains that various modifications and variations can be made without departing from the essential characteristics of the present embodiment. Accordingly, the present embodiments are not intended to limit the technical ideas of the present embodiment but to describe them, and the scope of the technical ideas of the present embodiment should not be limited by these embodiments. The scope of protection of the present embodiment should be interpreted based on the following claims, and all technical ideas within the equivalent scope thereof should be interpreted as being included within the scope of rights of the present embodiment.

What is claimed is:

1. An electronic device for personalizing an artificial intelligence model, comprising:
a processor; and
a memory operatively coupled to the processor,
wherein the memory stores instructions that, when executed, cause the processor to:
identify a bipartite graph based on a first user and a first response of the first user,
identify a first latent variable reflecting a preference of the first user based on the bipartite graph, and
connect the first user to one of at least one sub-module included in a first artificial intelligence model based on the first latent variable, and
wherein the first response comprises at least one output generated by the first artificial intelligence model and a preference of the first user for the at least one output.

2. The electronic device of claim 1, wherein the bipartite graph:
comprises, as nodes, each of the first user and the at least one output for which the first user has indicated a preference, and
comprises an edge connecting the node of the first user and the node of the at least one output.

3. The electronic device of claim 2, wherein, based on the first user having provided feedback on a first output of the at least one output as a preferred output, the bipartite graph comprises the node of the first user and the node of the first output being connected by a first edge.

4. The electronic device of claim 3, wherein, based on the first user having provided feedback on a second output of the at least one output as a non-preferred output, the bipartite graph comprises the node of the first user and the node of the second output being connected by a first negative edge.

5. The electronic device of claim 1, wherein the instructions cause the processor to:
input the first response into a second artificial intelligence model, and
receive the bipartite graph from the second artificial intelligence model.

6. The electronic device of claim 1, wherein the instructions cause the processor to:
input the bipartite graph into a third artificial intelligence model, and
receive the first latent variable for the first user from the third artificial intelligence model.

7. The electronic device of claim 1, wherein the first latent variable reflects preferences of the first user for each of the at least one output.

8. The electronic device of claim 7, wherein, based on the first user having provided feedback on a first output of the at least one output as a preferred output, and a second user having provided feedback on the first output of the at least one output as a preferred output,
the bipartite graph comprises:
a node of the first user and a node of the first output being connected by a first edge, and
a node of the second user and the node of the first output being connected by a second edge, and
wherein the first latent variable for the first user and a second latent variable for the second user, which are connected to each other via the node of the first output, have similar values within a predetermined error range.

9. The electronic device of claim 8, wherein the second latent variable reflects a preference of the second user based on the bipartite graph, and
wherein the instructions cause the processor to:
input the bipartite graph into a third artificial intelligence model, and
receive the first latent variable and the second latent variable from the third artificial intelligence model.

10. The electronic device of claim 1, wherein the instructions cause the processor to:
input the first latent variable into a fourth artificial intelligence model, and
receive information on a probability that the first user and each of the at least one sub-module will be connected, from the fourth artificial intelligence model.

11. The electronic device of claim 10, wherein the instructions cause the processor to:
connect the first user to a sub-module having the highest probability out of the at least one sub-module, based on the information.

12. The electronic device of claim 1, wherein the instructions cause the processor to:
identify an unseen user not included in the bipartite graph and a second response comprising a preference of the unseen user for the at least one output, and
based on the second response including having fed back preferences for a first output and a second output of the at least one output,
identify the first user connected via the first output,
identify a probability that the first user prefers both the first output and the second output, and
identify a second latent variable for the unseen user based on the probability and the first latent variable for the first user.

13. The electronic device of claim 12, wherein the instructions cause the processor to:
input the first latent variable for the first user into a fifth artificial intelligence model, and
receive and identify the probability from the fifth artificial intelligence model.

14. A method for personalizing an artificial intelligence model, comprising the steps of:
identifying a bipartite graph based on a first user and a first response of the first user;
identifying a first latent variable reflecting a preference of the first user based on the bipartite graph; and
connecting the first user to one of at least one sub-module included in a first artificial intelligence model based on the first latent variable,
wherein the first response comprises at least one output generated by the first artificial intelligence model and a preference of the first user for the at least one output.

15. The method of claim 14, wherein the bipartite graph:
comprises, as nodes, each of the first user and the at least one output for which the first user has indicated a preference, and
comprises an edge connecting the node of the first user and the node of the at least one output.

16. The method of claim 14, wherein the step of identifying the bipartite graph comprises the steps of:
inputting the first response into a second artificial intelligence model; and
receiving the bipartite graph from the second artificial intelligence model.

17. The method of claim 14, wherein the step of identifying the first latent variable comprises the steps of:
inputting the bipartite graph into a third artificial intelligence model; and
receiving the first latent variable for the first user from the third artificial intelligence model.

18. An electronic device for personalizing an artificial intelligence model, comprising:
a processor; and
a memory operatively coupled to the processor,
wherein the memory stores instructions that, when executed, cause the processor to:
identify a bipartite graph based on a first user and a first response of the first user,
identify, by using a first artificial intelligence model, a first latent variable reflecting a preference of the first user from the bipartite graph, and
identify, by using a second artificial intelligence model, the first user being connected to one of at least one sub-module included in the first artificial intelligence model based on the first latent variable, and
wherein the first response comprises at least one output generated by a third artificial intelligence model and a preference of the first user for the at least one output.

19. The electronic device of claim 18, wherein the instructions cause the processor to:
input the first response to a fourth artificial intelligence model, and
receive the bipartite graph from the fourth artificial intelligence model.

20. The electronic device of claim 18, wherein the first latent variable reflects preferences of the first user for each of the at least one output.
